(19) United States
(12) Patent Application Publication
(10) Pub. No.: US 2005/0164085 A1
(43) Pub. Date: Jul. 28, 2005

(54) Cathode material for lithium battery

(76) Inventors: Todd E. Bofinger, Nashua, NH (US); William L. Bowden, Nashua, NH (US); Rimma A. Sirotina, Ashland, MA (US); Fan Zhang, Norwood, MA (US)

Correspondence Address: FISH & RICHARDSON PC, 225 FRANKLIN ST, BOSTON, MA, 02110, US

(21) Appl. No.: 10/761,415

(22) Filed: Jan. 22, 2004

(51) Int. Cl. H01M 4/50; C01G 45/12

(52) U.S. Cl. 429/224; 429/231.1; 423/599

(57) ABSTRACT

A lithium battery includes a cathode including lithiated gamma-manganese dioxide. The battery can have high current capability and discharge capacity greater than a lithium-manganese dioxide battery including heat treated manganese dioxide.

### TECHNICAL FIELD

This invention relates to a cathode material for lithium batteries.

### BACKGROUND

Batteries are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

### SUMMARY

In general, a lithium battery includes a cathode including lithiated manganese dioxide.

In one aspect, a method of making a lithiated manganese dioxide for a primary lithium battery includes contacting a manganese dioxide with a lithium ion source at a lithiation temperature sufficient to substantially replace protons in the manganese dioxide with lithium ions, and heating the manganese dioxide at a water removal temperature sufficient to substantially remove residual and surface water to produce a lithiated manganese dioxide having an X-ray diffraction pattern substantially similar to the X-ray diffraction pattern of the manganese dioxide prior to lithiation.

In another aspect, a method of making a cathode for a battery includes contacting a manganese dioxide with a lithium ion source, heating the manganese dioxide to produce a lithiated manganese dioxide having an X-ray diffraction pattern substantially similar to the X-ray diffraction pattern of the manganese dioxide prior to lithiation, and coating a current collector with a composition including a carbon source, and the cathode active material, wherein the cathode active material includes the manganese dioxide.

In another aspect, a primary lithium battery includes an anode including a lithium-containing anode active material, a cathode including a lithiated manganese dioxide having an X-ray diffraction pattern substantially similar to the X-ray diffraction pattern of the manganese dioxide prior to lithiation, and a separator between the anode and the cathode.

The manganese dioxide can be persulfate derived chemical manganese dioxide, an electrochemical manganese dioxide, or gamma-manganese dioxide. The lithium ion source can be an aqueous solution including a lithium salt, such as a lithium hydroxide. The lithiation temperature can be between 40 C and 100 C. The water removal temperature can be between 180 C and 500 C, for example, between 200 C and 460 C.

In the battery, the lithium-containing anode active material can be lithium or a lithium alloy. The battery can include a nonaqueous electrolyte in contact with the anode, the cathode and the separator. The nonaqueous electrolyte can include an organic solvent. The lithiated gamma-manganese dioxide can have an X-ray diffraction pattern having peaks near 24 and 32 degrees 2-theta (CuKα radiation) and can have substantially all or most of the proton content normally present in gamma-manganese dioxide replaced by lithium ions. The battery can have high current capability and discharge capacity greater than a lithium/manganese dioxide battery including heat-treated manganese dioxide (HEMD).

The lithiated manganese dioxide can be used in a Li/MnO₂ battery that possesses improved capacity and running voltage in high drain conditions and can have reduced gas evolution compared to conventional Li/MnO₂ batteries. For example, the lithiated gamma-manganese dioxide can be suitable for use in batteries for digital cameras. A primary lithium battery including the lithiated manganese dioxide can have high running voltage, current capability and discharge capacity compared to a lithium/manganese dioxide battery including heat treated manganese dioxide (HEMD). The lithiated manganese dioxide can also evolve less gas during storage in a battery. The lithiated manganese dioxide has a low surface area and high electrical performance. The lithiated manganese dioxide has an X-ray diffraction pattern substantially identical to that of the parent manganese dioxide starting material even though the proton content of the manganese dioxide has been substantially completely replaced with lithium.

The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic drawing of a battery.

FIG. 2A is a representative X-ray diffraction pattern of highly proton containing gamma-manganese dioxide.

FIG. 2B is a representative X-ray diffraction pattern of a lithium exchanged gamma-manganese dioxide dried between 200 and 400 C of the present invention.

FIG. 2C is a representative X-ray diffraction pattern of a heat-treated manganese dioxide (HEMD) FIG. 2D is a representative X-ray diffraction pattern of a persulphate prepared manganese dioxide (p-CMD).

FIG. 2E is a representative X-ray diffraction pattern of a heat-treated lithiated persulphate prepared manganese dioxide (Li-p-CMD).

FIG. 2F is a representative X-ray diffraction pattern of a heat treated lithium exchanged manganese dioxide of U.S. Pat. No. 6,190,800.

FIG. 3A is the capacity spectrum of heat treated manganese dioxide (HEMD) and lithium treated persulphate prepared manganese dioxide (Li-p-CMD) as a function of discharge voltage.

FIG. 3B is a representative electrochemical spectrum of lithiated persulphate manganese dioxide and heat-treated manganese dioxide.

FIG. 3C is a representative electrochemical spectrum of lithiated persulfate manganese dioxide and persulfate manganese dioxide.

FIG. 3D is a representative electrochemical spectrum of lithiated gamma-manganese dioxide and lithium containing heat treated manganese dioxide.

### DETAILED DESCRIPTION

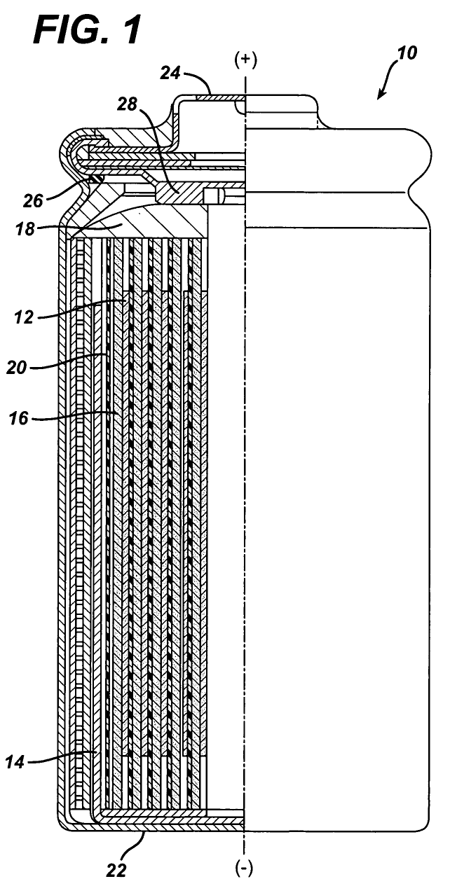

Referring to FIG. 1, a primary lithium electrochemical cell 10 includes an anode 12 in electrical contact with a negative lead 14, a cathode 16 in electrical contact with a crown 18, a separator 20 and an electrolyte. Anode 12, cathode 16, separator 20 and the electrolyte are contained within housing 22. The electrolyte can be a solution that includes a solvent system and a salt that is at least partially dissolved in the solvent system. One end of housing 22 is closed with a positive external contact 24 and an annular insulating gasket 26 that can provide a gas-tight and fluid-tight seal. Crown 18 and positive lead 28 can connect cathode 16 to positive external contact 24. A safety valve is disposed in the inner side of positive external contact 24 and is configured to decrease the pressure within battery 10 when the pressure exceeds some predetermined value. In certain circumstances, the positive lead can be circular or annular and be arranged coaxially with the cylinder, and include radial extensions in the direction of the cathode. Electrochemical cell 10 can be, for example, a cylindrical wound cell, a button or coin cell, a prismatic cell, a rigid laminar cell or a flexible pouch, envelope or bag cell.

Anode 12 can include alkali and alkaline earth metals, such as lithium, sodium, potassium, calcium, magnesium, or alloys thereof. The anode can include alloys of alkali or alkaline earth metals with another metal or other metals, for example, aluminum. An anode including lithium can include elemental lithium, a lithium-insertion compound, or lithium alloys, or combinations thereof.

The electrolyte can be a nonaqueous electrolyte solution including a solvent and a salt. The electrolyte can be a liquid or a polymeric electrolyte. The salt can be an alkali or alkaline earth salt such as a lithium salt, a sodium salt, a potassium salt, a calcium salt, a magnesium salt, or combinations thereof. Examples of lithium salts include lithium hexafluorophosphate, lithium tetrafluoroborate, lithium hexafluoroarsenate, lithium perchlorate, lithium iodide, lithium bromide, lithium tetrachloroaluminate, lithium trifluoromethanesulfonate, LiN(CF₃SO₂)₂, and LiB(C₆H₄O₂)₂. A perchlorate salt such as lithium perchlorate can be included in the electrolyte to help suppress corrosion of aluminum or an aluminum alloy in the cell, for example in the current collector. The concentration of the salt in the electrolyte solution can range from 0.01 molar to 3 molar, from 0.5 molar to 1.5 molar, and in certain embodiments can be 1 molar.

The solvent can be an organic solvent. Examples of organic solvents include carbonates, ethers, esters, nitrites and phosphates. Examples of carbonates include ethylene carbonate, propylene carbonate, diethyl carbonate and ethylmethyl carbonate. Examples of ethers include diethyl ether, dimethyl ether, dimethoxyethane, diethoxyethane and tetrahydrofuran. Examples of esters include methyl propionate, ethyl propionate, methyl butyrate and gamma-butyrolactone. Examples of nitrites include acetonitrile. Examples of phosphates include triethylphosphate and trimethylphosphate. The electrolyte can be a polymeric electrolyte.

Separator 20 can be formed of any separator material used in lithium primary or secondary battery separators. For example, separator 20 can be formed of polypropylene, polyethylene, polytetrafluoroethylene, a polyamide (e.g., a nylon), a polysulfone, a polyvinyl chloride, or combinations thereof. Separator 20 can have a thickness of from about 12 microns to about 75 microns and more preferably from 12 to about 37 microns. Separator 20 can be cut into pieces of a similar size as anode 12 and cathode 16 and placed therebetween as shown in FIG. 1. The anode, separator, and cathode can be rolled together, especially for use in cylindrical cells. Anode 12, cathode 16 and separator 20 can then be placed within housing 22 which can be made of a metal such as nickel or nickel plated steel, stainless steel, aluminum-clad stainless steel, aluminum, or an aluminum alloy or a plastic such as polyvinyl chloride, polypropylene, a polysulfone, ABS or a polyamide. Housing 22 containing anode 12, cathode 16 and separator 20 can be filled with the electrolytic solution and subsequently hermetically sealed with positive external contact 24 and annular insulating gasket 26.

Cathode 16 includes a composition that includes a lithiated manganese dioxide. The lithiated manganese dioxide can be prepared by treating a persulfate derived chemical manganese dioxide or gamma-manganese dioxide with a lithium ion source to replace the protons of the manganese dioxide with lithium ions. Preparation of persulfate derived chemical manganese dioxide (p-CMD) is described, for example, in U.S. Pat. Nos. 5,277,890, 5,348,728 and 5,482,796, each of which is incorporated by reference in its entirety. Preparation of heat treated manganese dioxide is described, for example, in U.S. Pat. No. 4,133,856, which is incorporated by reference in its entirety. Gamma-manganese dioxide is described, for example, in “Structural Relationships Between the Manganese (IV) Oxides”, Manganese Dioxide Symposium, 1, The Electrochemical Society, Cleveland, 1975, pp. 306-327, which is incorporated herein by reference in its entirety. The lithium ion source can be an aqueous solution including a lithium salt, such as, for example, lithium hydroxide. The lithium ion exchange can be performed at a temperature above room temperature, for example, between 40 C and 120 C, or at or between 60 C and 100 C.

The lithium-exchanged material is then heated to remove residual and surface moisture. The material can be heated in air, in oxygen, in inert atmosphere, or in a vacuum. The material can be heated to a temperature greater than 150 C, greater than 180 C, less than 500 C, or less than 480 C. This can convert the manganese dioxide to a lithiated gamma manganese dioxide phase or to a ramsdellite LiMD phase.

Gamma manganese dioxide can have the formula:
(a) MnO₂.(b) MnOOH.(c) δ(OH)₄
where the delta is used to indicate a cation vacancy in the Mn (IV) lattice. For example, in one composition, (a) is 0.9, (b) is 0.06, and (c) is 0.04. About half of the lattice protons in the manganese dioxide are replaced with lithium ions by exposing the manganese dioxide to aqueous lithium hydroxide at pH 13 at ambient temperature as disclosed in U.S. Pat. No. 6,190,800, which is incorporated by reference in its entirety. By performing the lithium exchange at higher temperature, for example, at 60 C or 100 C, it is possible to reduce or avoid destruction of cation vacancy sites and increase lithium uptake to replace 75 % or more of the protons originally present in the gamma-manganese dioxide.

In certain circumstances, the p-CMD can have a low BET surface area, for example, below 30 m²/gram. Other manganese dioxide materials that can be treated by this process can include alternative forms of gamma-manganese dioxide of artificial ramsdellite character, such as, for example, gamma-manganese dioxide materials derived by acid leaching of LiMn₂O₄ spinels, and by acid treatment of Mn₂O₃ and Mn₃O₄ may be suitable, or lambda-manganese dioxides. A stabilization of the lithiated manganese dioxide phase produced by heating lithiated p-CMD can be attributed, in part, to the high lithium content brought about by a high cation vacancy concentration. Accordingly, other manganese dioxide materials having a high cation vacancy level can be used in this process. In addition, under certain conditions, elevating the lithiation temperature can advantageously increase the lithium ion content of the material. For example, a lithium level of about Li_{0.22}MnO₂ heat treated for 6 hours at 200 C in air can form a material with BET surface area of about 15 m²/g. The material of choice can distinguished as having an X-ray diffraction pattern characteristic of gamma-manganese dioxide rather than the HEMD commonly used for Li cells.

The cathode composition can also include a binder, for example, a polymeric binder such as PTFE, PVDF, Kraton or Viton (e.g., a copolymer of vinylidene difluoride and hexafluoropropylene). The cathode composition can also include a carbon source, such as, for example, carbon black, synthetic graphite including expanded graphite or non-synthetic graphite including natural graphite, an acetylenic mesophase carbon, coke, graphitized carbon nanofibers or a polyacetylenic semiconductor.

The cathode includes a current collector on which the cathode active material can be coated or otherwise deposited. The current collector can have a region in contact with positive lead 28 and a second region in contact with the active material. The current collector serves to conduct electricity between the positive lead 28 and the active material. The current collector can be made of a material that is strong and is a good electrical conductor (i.e. has a low resistivity), for example a metal such as stainless steel, titanium, aluminum or an aluminum alloy. One form that the current collector can take is an expanded metal screen or grid, such as a non-woven expanded metal foil. Grids of stainless steel, aluminum or aluminum alloy are available from Exmet Corporation (Branford, Conn.).

In general, a cathode is made by coating a cathode material onto a current collector, drying and then calendering the coated current collector. The cathode material is prepared by mixing an active material together with other components such as a binder, solvent/water, and a carbon source. The current collector can include a metal such as titanium, stainless steel, aluminum, or an aluminum alloy. The current collector can be an expanded metal grid. To form the cathode material, an active material such as manganese dioxide can be combined with carbon, such as graphite and/or acetylene black, and mixed with small amount of water. The current collector is then coated with the cathode slurry.

In a cylindrical cell, the anode and cathode are spirally wound together with a portion of the cathode current collector extending axially from one end of the roll. The portion of the current collector that extends from the roll can be free of cathode active material. To connect the current collector with an external contact, the exposed end of the current collector can be welded to a metal tab, which is in electric contact with an external battery contact. The grid can be rolled in the machine direction, the pulled direction, perpendicular to the machine direction, or perpendicular to the pulled direction. The tab can be welded to the grid to minimize the conductivity of grid and tab assembly. Alternatively, the exposed end of the current collector can be in mechanical contact (i.e. not welded) with a positive lead which is in electric contact with an external battery contact. A cell having a mechanical contact can require fewer parts and steps to manufacture than a cell with a welded contact. The mechanical contact can be more effective when the exposed grid is bent towards the center of the roll to create a dome or crown, with the highest point of the crown over the axis of the roll, corresponding to the center of a cylindrical cell. In the crown configuration, the grid can have a denser arrangement of strands than in the non-shaped form. A crown can be orderly folded and the dimensions of a crown can be precisely controlled.

The positive lead 28 can include stainless steel, aluminum, or an aluminum alloy. The positive lead can be annular in shape, and can be arranged coaxially with the cylinder. The positive lead can also include radial extensions in the direction of the cathode that can engage the current collector. An extension can be round (e.g. circular or oval), rectangular, triangular or another shape. The positive lead can include extensions having different shapes. The positive lead and the current collector are in electrical contact. Electrical contact between the positive lead and the current collector can be achieved by mechanical contact. Alternatively, the positive lead and current collector can be welded together. The positive lead and the cathode current collector are in electrical contact. The electrical contact can be the result of mechanical contact between the positive lead and current collector.

### EXAMPLE 1

### Lithiated p-CMD

p-CMD was prepared as follows. Manganous sulfate (239 grams, 1.6 moles) was dissolved in 1.8 L water and sodium persulfate (346 grams 1.45 moles) as added and stirred to dissolve. The solution was heated with stirring to 55 C. After 5 hours the pH is 0.98 and considerable black solids were present in solution. The heat was removed and the solution allowed to stand overnight. LiOH solid was added to neutralize the acid created in the oxidation process, reaching a pH of 1.14. The solution was then heated to 84 C and pH drops to 0.48 through the day. A second neutralization with LiOH is carried out to a pH of 2.05. The solution was then heated to 90 C for one hour, allowed to cool and collected on a fritted glass filter. The collected precipitate was dried at 60 C overnight to form a cake that was dispersed in water and filtered to form a finely divided powder. Total yield of product was about 129 grams; 1.48 moles.

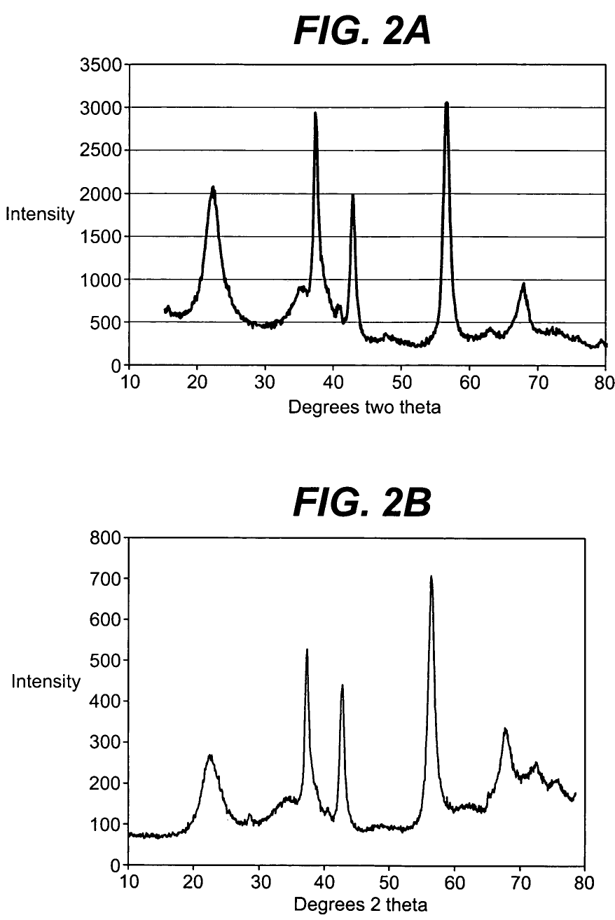

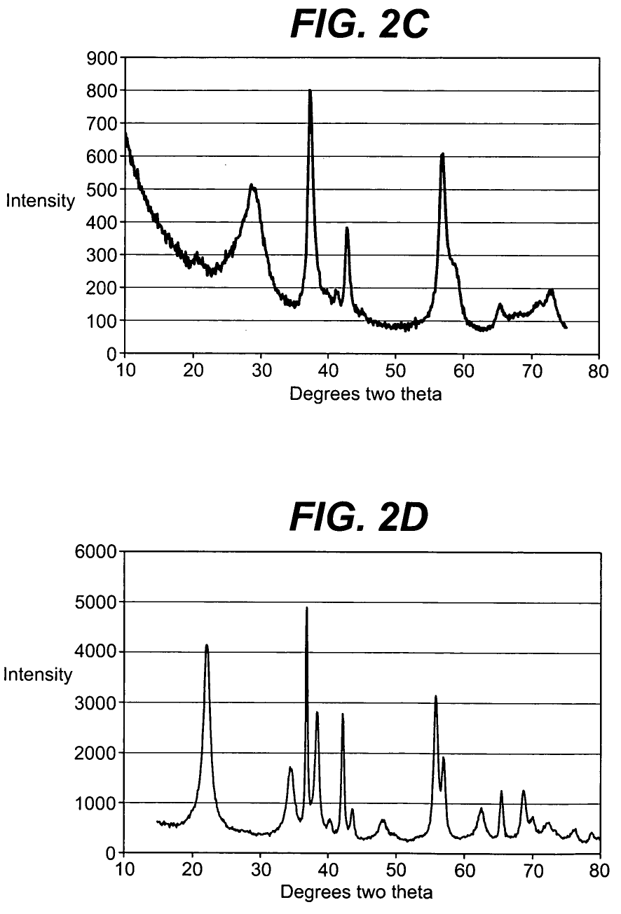

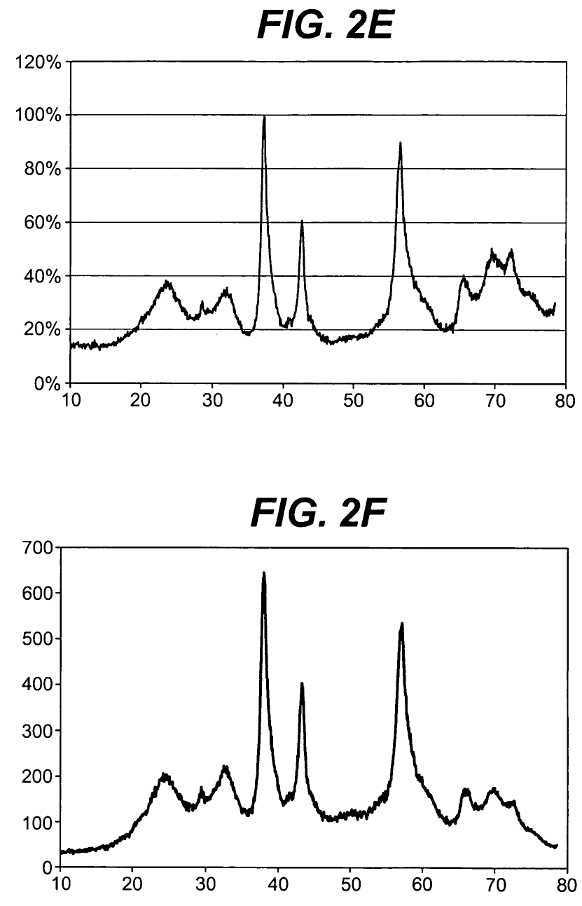

Lithium exchange was performed on the p-CMD as follows. p-CMD (50 grams, 0.6 moles) was dispersed in 50 ml deionized water and solid LiOH.H₂O (3.4 g, 0.08 moles) was added with continual stirring. The final pH reached after about 1 hours was 12.6. The slurry of MnO₂ in LiOH solution was put aside to stay overnight at high pH. The slurry was then filtered through a pressure filter to isolate the lithium-exchanged p-CMD. The wet p-CMD was left overnight to dry at room temperature, and was then dried at 60 C. Total yield of product is about 50.7 grams, 0.6 moles. The X-ray diffraction pattern of the persulphate prepared manganese dioxide is shown in FIG. 2D. The lithium-exchanged p-CMD was then heat treated at 350 C for 1 hour to produce the lithiated persulphate-manganese dioxide. The X-ray diffraction pattern of the lithiated persulphate-manganese dioxide was nearly identical to the pattern shown in FIG. 2E. In other examples, the lithiated p-CMD was heat treated at 450 C for different lengths of time.

### EXAMPLE 2

### Lithiated Gamma-Manganese Dioxide

EMD (Kerr-McGee High Power alkaline grade MnO₂)(300 g) was placed in a 2 L beaker and dispersed with about 1 L water. Sulfuric acid was added to remove exchangeable sodium. The suspension of MnO₂ in acid was filtered and the filtrate discarded leaving and acid-washed, sodium free MnO₂ as described in U.S. Pat. No. 5,698,176. The manganese dioxide was again dispersed in water, heated to 60 C on a hot plate and solid LiOH.H₂O (30.7 grams) was added with continual stirring while the pH was monitored. In contrast to lithiation at room temperature, where the nominal pH 13 was attained, the suspension remained at a pH of about 11.3. The slurry of MnO₂ in LiOH solution was put aside and allowed to stand overnight. The pH was then adjusted to the target pH of 12.5 with more solid lithium hydroxide. The slurry was then filtered through a fine porosity glass fritted filter or a pressure filter to isolate the lithium-exchanged manganese dioxide. The wet manganese dioxide was then dried overnight at 100 C to provide a dark brown powder. The observed lithium uptake corresponds to 0.21 Li per mole of MnO₂. To remove residual surface and lattice moisture the MnO₂ was then dried at 200 C for 6 hours. The 200 C drying temperature was selected since solid state MAS ⁶Li NMR measurements had shown that both Li and protons in EMD were mobile at 200 C. As shown by comparison of FIG. 2A (protonated gamma-manganese dioxide from Kerr-McGee) and FIG. 2B, the lithiated gamma-manganese dioxide was in the y-phase after drying at 200 C.

### COMPARATIVE EXAMPLE 1

### HEMD

Delta EMD lithium grade MnO₂) (1200 g) was placed in an oven and heated under flowing air at 350 degrees C. for a period of 7 hours. The temperature of the oven was gradually increased to reach 350 degrees over a 6 hours period followed by 7 hours at 350 C. The resulting material, HEMD has an X-ray diffraction pattern shown in FIG. 2C and is considered as being substantially the material of U.S. Pat. No. 4,133,856. This material is used as comparative Example 1 in subsequent Examples.

### COMPARATIVE EXAMPLE 2

### Lithiated Heat Treated Manganese Dioxide (LiMD)

Kerr-McGee High Power alkaline grade EMD or Delta EMD lithium grade MnO₂)(1200 g) was placed in a 2 L beaker and dispersed with about 1 L water. Solid LiOH.H₂O was added with continual stirring while the pH was monitored. When the desired pH near 12.5 was reached the slurry of MnO₂ in LiOH solution was put aside and allowed to stand overnight. The pH was then adjusted to the target pH of 12.5 with more solid lithium hydroxide. The overnight stand in lithium hydroxide solution can allow the diffusion of protons and lithium ions within the manganese dioxide to equilibrate and allow maximum replacement of protons by lithium. The slurry was then filtered through a fine porosity glass fritted filter or a pressure filter to isolate the lithium-exchanged manganese dioxide. The wet manganese dioxide was then dried overnight at 100 C to provide a dark brown powder. To remove residual surface and lattice moisture the MnO₂ was then dried at 350 C for 6 hours in air. The temperature can be raised as high as 400 C without changing the product of the reaction, but that heating that causes Mn₂O₃ to be produced, for example, heating to 450 C in air, can indicate a deleterious loss of oxygen has taken place. Again, the lithiated manganese dioxide had a diffraction pattern as represented in FIG. 2F and indicating that it is a material as described in U.S. Pat. No. 6,190,800.

### EXAMPLE 4

### SPECS

The lithiated gamma-manganese dioxide products of Examples 1-2 were distinguished from heat treated manganese dioxide (HEMD) and lithium exchanged heat treat EMD (LiMD) of Comparative examples 1 and 2 by use of the SPECS low rate discharge test. In the SPECS test a cell is discharged at a constant voltage for a pre-selected period of time, then stepped to a new voltage. SPECS has been described in, for example, A. H. Thompson, Electrochemical Potential Spectroscopy: A New Electrochemical Measurement, J. Electrochemical Society 126(4), 608-616 (1979); Y. Chabre and J. Pannetier, Structural and Electrochemical Properties of the Proton/γ-MnO₂ System, Prog. Solid St. Chem. 23, 1-130 (1995); and references therein, each of which is hereby incorporated by reference in its entirety. One of the outputs of this experiment is a voltage spectrum that addresses the questions of how quickly a material can discharge at a given voltage.

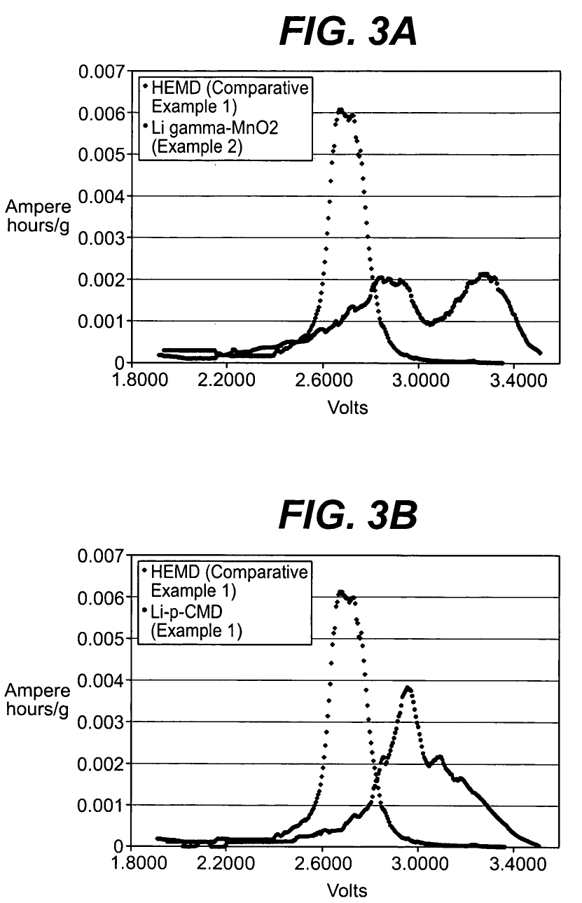

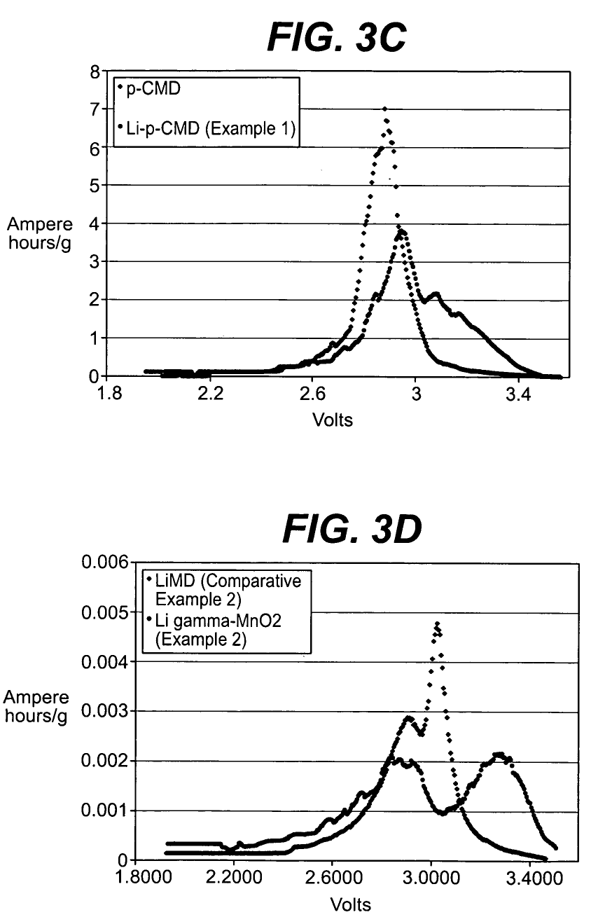

The SPECS curves of the lithiated gamma-manganese dioxide of Example 2 and HEMD is shown in FIG. 3A. As shown in FIG. 3A, the lithiated gamma-manganese dioxide of Example 1 has a higher initial discharge process centered about 3.25 V and a second discharge process centered about 2.87 V as compared to the single process centered about 2.68 V for the HEMD of comparative Example 1. The high voltage of the material of Example 1 is improved over comparative Example 1 provides a higher running voltage during discharge.

The SPECS curves of the lithiated persulphate-manganese dioxide of Example 1 and HEMD is shown in FIG. 3B As shown in FIG. 3B, the lithiated persulphate manganese dioxide undergoes a variety of discharge processes with the two most prominent processes centered about 3.07 and 2.94 V vs. the single process centered about 2.68 V seen for HEMD.

The electrochemical spectra of the heat-treated lithiated persulphate manganese dioxide is compared with the SPECS curve of the parent persulphate manganese dioxide in FIG. 3C. As shown in FIG. 3C, the lithiated persulphate manganese dioxide has a higher running voltage after 350 C treatment than the persulphate manganese dioxide after heat treatment.

The electrochemical spectra of heat-treated lithium containing manganese dioxide of Comparative Example 2 and Example 2 of the current invention are presented in FIG. 3D. As shown in FIG. 3D, the Example 1 material shows higher voltage and therefore better running voltage in a battery.

### EXAMPLE 5

### Foil Bag Gas Test

Gas evolution by the lithiated gamma-manganese dioxide in contact with electrolyte was tested. The foil bag gas tests were conducted on HEMD, the lithiated p-CMD after heat treatment at 350 C of Example 1, lithiated gamma-manganese dioxide after heat treatment to 200 C of Example 2 lithiated-manganese dioxide after heat treatment to 350 C in air for 7 hours of Comparative Example 2 and the HEMD of Comparative Example 1. In a foil bag gas test, both electrolyte (10 w/o EC 20 w/o PC and 70 w/o DME with 0.6 M LiTFS) (1.8 grams) and the lithiated manganese dioxide (6.5 grams) were sealed in an aluminized Mylar bag and stored at 60 C. Gas evolution was determined by displacement and weight under water. BET surface area was also determined. Results are listed in Table 1 and show the Example 2 lithiated gamma-manganese dioxide produces less gas than either comparative Example 1 or comparative Example 2 and that the Example 1 lithiated persulphate manganese dioxide of Example 1 produces only slightly more gas than comparative Examples 1 and 2.

TABLE 1

| | | | Lithiated gamma- | Lithiated gamma- |
|---|---|---|---|---|
| | HEMD | Lithiated | manganese | manganese dioxide heated |
| | (Comparative | p-CMD of | dioxide of | to 350 C in air for 7 h |
| Property | Example 1) | Example 1 | Example 2 | (Comparative Example 2) |
| Li (%) | 0.0 | 0.68 | 1.19 | 0.86 |
| Total Mn (%) | 61.6 | 60.9 | 59.4 | 60.8 |
| x in MnOₓ | 1.97 | 1.95 | 1.98 | 1.94 |
| Density (g/cm³) | 4.77 | 4.57 | 4.378 | 4.50 |
| BET surface area (m²/g) | 30.8 | 37.18 | 15.7 | 30.2 |
| Average pore diameter (Å) | 92.7 | 208.4 | 98.19 | 76.2 |
| Total pore volume (cm³/g) | 0.0715 | 0.1937 | 0.0366 | 0.0575 |
| Gas after 1 day (cm³) | 21.5 | 27.07 | 7.7 | 16.01 |
| Gas after 1 week (cm³) | 34.15 | 44.44 | 18.24 | 33.15 |
| Gas after 2 weeks (cm³) | 40.61 | 54.6 | 24.68 | 39.94 |
| Gas after 4 weeks relative | — | 138 | 70 | 108 |
| to HEMD (%) | | | | |

### EXAMPLE 6

### Scaled Optio Tests

Electrochemical performance of 2430-size coin cells including the lithiated gamma-manganese dioxide cathode material and a lithium anode was tested. The Optio test conditions are summarized in Table 2.

TABLE 2

| | FLASH ON - LCD ON | | | | FLASH OFF - LCD ON | | | |
|---|---|---|---|---|---|---|---|---|
| | | | 2430 | | | 7-mm, | 2430 | |
| Function | Step # | Actual | (Watts) | Time (s.) | Step # | 2/3A (W) | (Watts) | Time (s.) |
| LCD | Step 1 | 2.9 | 0.0829 | 0.5 | Step 1 | 2.9 | 0.0829 | 0.5 |
| Zoom | Step 2 | 4.87 | 0.1391 | 0.5 | Step 2 | 4.87 | 0.1391 | 0.5 |
| Process | Step 3 | 2.9 | 0.0829 | 1 | Step 3 | 2.9 | 0.0829 | 2 |
| AF | Step 4 | 4.87 | 0.1391 | 0.5 | Step 4 | 4.87 | 0.1391 | 0.5 |
| Process | Step 5 | 2.9 | 0.0829 | 1 | Step 5 | 2.9 | 0.0829 | 1 |
| Shutter | Step 6 | 6 | 0.1714 | 0.1 | Step 6 | 6 | 0.1714 | 0.1 |
| Process | Step 7 | 2.9 | 0.0829 | 1 | Step 7 | 3 | 0.0857 | 2.4 |
| Flash Rchg | Step 8 | 5 | 0.1429 | 1 | | | | |
| Process | Step 9 | 3 | 0.0857 | 0.4 | | | | |
| LCD Stby | Step 10 | 2.9 | 0.0829 | 14 | Step 8 | 2.9 | 0.0829 | 13 |
| Rest | Step 11 | 0 | 0 | 40 | Step 9 | 0 | 0 | 40 |
| Weighted Avg | | 3.1 | | | | 3 | | |

One test that was performed was the Optio digital camera test. The Optio test was determined by taking the load regime for the Optio 330 camera and scaling it to fit the 2430 size coin cell. It consists of a series of pulses to simulate the loads place on a battery in service in a camera. Cells were prepared containing HEMD (Comparative Example 1), p-CMD (control), Li-p-CMD of Example 1, and the lithiated manganese dioxide of Example 2 and were tested in fresh conditions. Five to eight cells were tested and the results were averaged. The number of cycles achieved above the threshold voltages of 2.5, 2.0, 1.8 and 1.5 are summarized in Table 3.

TABLE 3

| Manganese dioxide | 2.5 V | 2.0 V | 1.8 V | 1.5 V |
|---|---|---|---|---|
| HEMD | 2 | 174 | 194 | |
| Standard Deviation | 0 | 44 | 41 | |
| Confidence | | 31 | 28 | |
| p-CMD | | 277 | 301 | 318 |
| Standard Deviation | | 29 | 27 | 21 |
| Confidence | | 22 | 20 | 15 |
| Li-p-CMD (Example 1) | 226 | 331 | 341 | 349 |
| Standard Deviation | 14 | 13 | 13 | 9 |
| Confidence | 11 | 9 | 9 | 6 |
| Lithiated gamma- | 219 | 287 | 299 | |
| manganese dioxide | | | | |
| (Example 2) | | | | |
| Standard Deviation | 15 | 17 | 20 | |
| Confidence | 10 | 12 | 14 | |

As shown in Table 2, the Li-p-CMD of Example 1 and the lithiated gamma-manganese dioxide of Example 2 outperformed the HEMD material to the standard cutoff of 2.0 V and delivered more service on higher cutoff voltages. The high performance of the Li-p-CMD of Example 1 and lithiated gamma-manganese dioxide was also demonstrated by the high average running voltage. The lithiated gamma-manganese dioxide offers excellent service even to the 2.5 V cutoff. Initial and final voltage on a high drain step of the Optio protocol was plotted and the voltage at the mid-point of the discharge was taken as a measure of quality of service on the Optio test. When evaluated by this technique, the cells with HEMD has an average load voltage of 2.35 while the cells with Li-p-CMD of Example 1 had an average voltage of 2.68 (a 330 mV advantage) and the cells with lithiated gamma-manganese dioxide had an average voltage of 2.78 (a 430 mV advantage).

A number of embodiments have been described. Nevertheless, it will be understood that various modifications may be made. Accordingly, other embodiments are within the scope of the following claims.

1. A method of making a lithiated manganese dioxide for a primary lithium battery comprising:
contacting a manganese dioxide with a lithium ion source at a lithiation temperature sufficient to substantially replace protons in the manganese dioxide with lithium ions; and
heating the manganese dioxide at a water removal temperature sufficient to substantially remove residual and surface water to produce a lithiated manganese dioxide having an X-ray diffraction pattern substantially similar to the X-ray diffraction pattern of the manganese dioxide prior to lithiation.

2. The method of claim 1, wherein the manganese dioxide is persulfate derived chemical manganese dioxide.

3. The method of claim 1, wherein the manganese dioxide is gamma-manganese dioxide.

4. The method of claim 1, wherein the lithium ion source is an aqueous solution including a lithium salt.

5. The method of claim 4, wherein the lithium salt is a lithium hydroxide.

6. The method of claim 1, wherein the lithiation temperature is between 40 C and 100 C.

7. The method of claim 1, wherein the water removal temperature is between 180 C and 500 C.

8. The method of claim 1, wherein the water removal temperature is between 200 C and 460 C.

9. A method of making a cathode for a battery comprising:
contacting a manganese dioxide with a lithium ion source;
heating the manganese dioxide to produce a lithiated manganese dioxide having an X-ray diffraction pattern substantially similar to the X-ray diffraction pattern of the manganese dioxide prior to lithiation; and
coating a current collector with a composition including a carbon source, and the cathode active material, wherein the cathode active material includes a manganese dioxide.

10. The method of claim 9, wherein the manganese dioxide is persulfate derived chemical manganese dioxide.

11. The method of claim 9, wherein the manganese dioxide is gamma-manganese dioxide.

12. The method of claim 9, wherein the lithium ion source is an aqueous solution including a lithium salt.

13. The method of claim 12, wherein the lithium salt is a lithium hydroxide.

14. The method of claim 9, wherein the lithiation temperature is between 40 C and 100 C.

15. The method of claim 9, wherein the water removal temperature is between 180 C and 500 C.

16. The method of claim 9, wherein the water removal temperature is between 200 C and 460 C.

17. A primary lithium battery comprising:
an anode including a lithium-containing anode active material;
a cathode including a lithiated manganese dioxide having an X-ray diffraction pattern substantially similar to the X-ray diffraction pattern of the manganese dioxide prior to lithiation; and
a separator between the anode and the cathode.

18. The battery of claim 17, wherein the lithium-containing anode active material is lithium or a lithium alloy.

19. The battery of claim 17, further comprising a nonaqueous electrolyte in contact with the anode, the cathode and the separator.

20. The battery of claim 19, wherein the nonaqueous electrolyte includes an organic solvent.

21. The battery of claim 17, wherein the battery has high current capability and discharge capacity greater than a lithium-manganese dioxide battery including heat treated manganese dioxide.
